(19) United States
(12) Patent Application Publication
(10) Pub. No.: US 2009/0229206 A1
(43) Pub. Date: Sep. 17, 2009

(54) DECORATIVE HOLOGRAPHIC TILE

(76) Inventor: Daniel Christman, Franksville, WI (US)

Correspondence Address: ZIOLKOWSKI PATENT SOLUTIONS GROUP, SC (ZPS), 136 S WISCONSIN ST, PORT WASHINGTON, WI, 53074, US

(21) Appl. No.: 12/045,957

(22) Filed: Mar. 11, 2008

(51) Int. Cl. B44F 7/00; E04F 13/14

(52) U.S. Cl. 52/311.1; 52/745.19

(57) ABSTRACT

A decorative tile element is configured for use as a shower tile, a floor tile, a wall tile, or a backsplash tile. The decorative tile element includes a tile substrate and a holographic film element. The holographic film element is attached to the tile substrate by way of a first resin layer and is configured to receive ambient light and diffract the ambient light to produce a holographic image. A second resin layer is affixed to the holographic film element to attach a cover element over the holographic film element. The cover element is configured to allow the passage of the ambient light therethrough.

### BACKGROUND OF THE INVENTION

The present invention relates generally to decorative tile elements and, more particularly, to a decorative holographic tile that includes a glass-inlaid holographic film.

The use of ornate but functional construction materials such as tile in bathroom and shower areas and in flooring is well-known. Such tiles can take many forms and can be constructed of aesthetically pleasing materials and/or include decorative designs thereon. For example, stone or marble tiling is commonly found in flooring or in bathroom décor to enhance the appearance of these structures. Additionally, tiles can include decorative and ornate characteristics, such as floral patterns, that are contained within a laminate structured tile.

While a myriad of tile designs are currently available, there is an ever-present demand for new tile structures that incorporate designs or materials not currently used. Ornate tiles incorporating expensive materials are desired to further enhance the appearance of existing tile structures and can be used in combination with existing tiles to create unique, decorative patterns. When incorporating these “decorative tiles,” it is desired that such tiles be visually distinct from the surrounding tiles. Thus, decorative tiles that can make use of ambient light from the surrounding environment to brighten the interior of a shower stall while still presenting a decorative pattern thereon are highly desirable.

Other considerations are also present in constructing decorative tiles. That is, bathroom and shower areas are subject to high humidity at various periods of time. For decorative tiles incorporating materials sensitive to such humidity, it is necessary to protect those materials from the surrounding humid environment. For laminate tiles having humidity sensitive decorative materials included therein, sealing must be provided to prevent moisture from creeping in between laminate layers in the tile.

Therefore, it would be desirable to design a visually distinct decorative tile that is configured to make use of ambient light from the surrounding environment and that presents a decorative pattern. It would also be desirable for such a decorative tile to be constructed such that it is suitable for use in a high humidity environment, such as a bathroom or shower stall.

### BRIEF DESCRIPTION OF THE INVENTION

The present invention is directed to a decorative holographic tile for use as a shower tile, a floor tile, a wall tile, or a backsplash tile.

In accordance with one aspect of the invention, a decorative tile element includes a tile substrate, a first resin layer affixed to the tile substrate, and a holographic film element attached to the first resin layer and configured to receive ambient light and diffract the ambient light. A second resin layer is affixed to the holographic film element and a cover element is attached to the second resin layer and configured to allow the passage of the ambient light therethrough.

In accordance with another aspect of the invention, a holographic tile for use as a decorative element includes a metalized polyethylene terephthalate (PET) film having a front side and a back side. The front side of the PET film is configured to diffract light received thereby to produce a holographic image. The holographic tile also includes a resin applied to each of the front and back sides of the metalized PET film, a transparent surface element bonded to the resin and adjacent to the front side of the metalized PET film, and a substrate bonded to the resin and adjacent to the back side of the metalized PET film.

In accordance with yet another aspect of the invention, a method of constructing a decorative tile includes the steps of affixing a back surface of a holographic film element to a tile substrate and applying a transparent resin to a front surface of the holographic film element, the front surface of the holographic film element configured to receive and diffract ambient light. The method also includes the step of securing a cover element to the transparent resin applied to the front surface of the holographic film element, wherein the cover element is configured to allow the passage of the ambient light therethrough.

Various other features and advantages of the present invention will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a pictorial view of a shower stall and decorative tile arrangement.

FIG. 2 is a cross-sectional view of a holographic tile according to an embodiment of the present invention.

FIG. 3 is a cross-sectional view of a holographic tile according to another embodiment of the present invention.

FIG. 4 is a top view of a holographic film element according to an embodiment of the present invention.

FIG. 5 is a cross-sectional view of a holographic film element according to another embodiment of the present invention.

### DETAILED DESCRIPTION OF THE INVENTION

The present invention is directed to a decorative holographic tile that is configured to be used as a shower tile, a floor tile, a wall tile, or a backsplash tile.

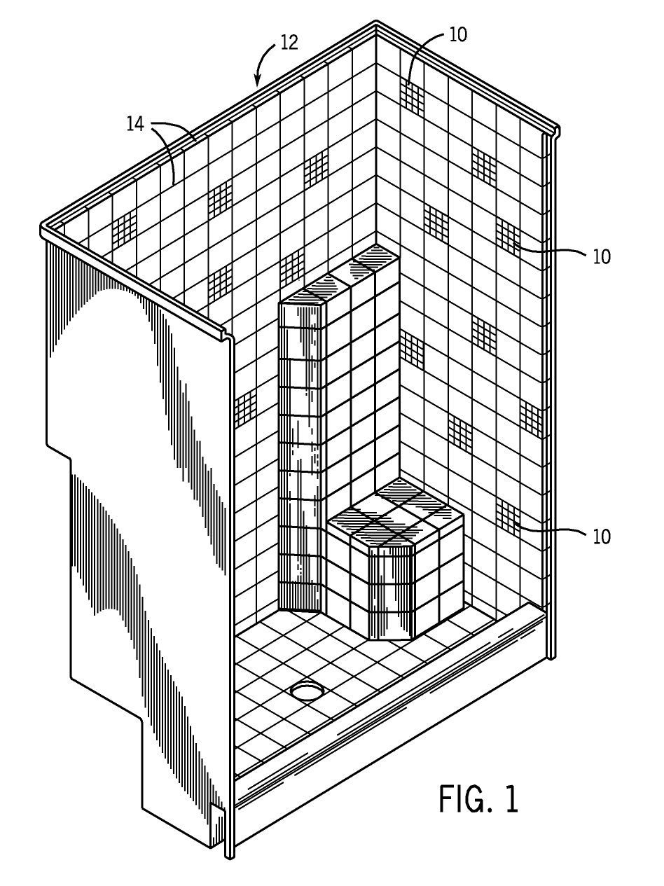

Referring to FIG. 1, a decorative tile element 10 is shown included in a shower stall 12. A plurality of decorative tile elements 10 are positioned at varying locations in shower stall 12 and are mixed with stone or ceramic tiles 14 that typically make up a majority of the walls in shower stall 12. A smaller number of decorative tile elements 10 are mixed with the stone/ceramic tiles 14 to provide decorative accents in shower stall 12.

Each of decorative tile elements 10 comprises a holographic tile that that is configured to diffract light received thereby to produce a holographic image. That is, the holographic tiles 10 receive ambient light from the surrounding environment and are configured to diffract that light to produce a holographic image or pattern. Such holographic images/patterns on the holographic tiles 10 makes those tiles visually distinct from the surrounding tiles, thus enhancing the appearance of shower stall 12. Additionally, by making use of ambient light from the surrounding environment and diffracting that light to produce rainbow colored images/patterns, holographic tiles 10 serve to brighten the interior of shower stall 12.

While shown as being included in a shower stall 12, it is also envisioned that decorative tile elements 10 can also be used as floor tiles, wall tiles, or backsplash tiles. Dependent on the desired usage, decorative tile elements 10 can be sized and shaped accordingly. That is, floor tiles may be sized larger than shower tiles or backsplash tiles, and it is recognized that the decorative tile elements 10 of the present invention are not limited by their specific size or shape.

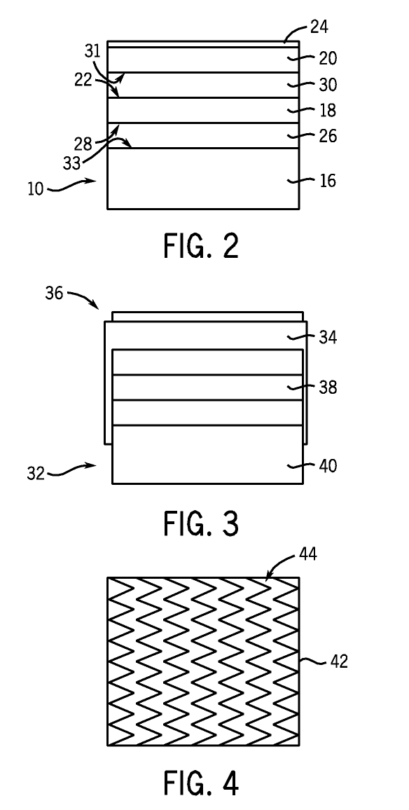

Referring now to FIG. 2, a detailed view of a holographic tile 10 is shown. Holographic tile 10 includes therein a tile substrate 16 that forms a back surface of the tile 10. That is, tile substrate 16 serves as the surface of holographic tile 10 that is mounted to a wall or floor surface for affixing the tile within a shower stall, floor, wall, or backsplash. Positioned adjacent to tile substrate 16 is a holographic film element 18. In one embodiment, holographic film element 18 is comprised of a metalized polyethylene terephthalate (PET) film, although it is also envisioned that other suitable holographic materials could also be substituted for the PET film. Also included in holographic tile 10 is a cover element 20 is placed on top of holographic film element 18. The cover element 20 is comprised on a transparent substance, so as to allow for ambient light to pass therethrough and be received by a front surface 22 of holographic film element 18. In one embodiment, cover element 20 comprises a ¼″ thick glass cover, although it is also envisioned that the cover element could be formed from an acrylic cast clear plastic or other suitable material. In the embodiment shown in FIG. 2, an anti-reflective film 24 is deposited on an outer surface of cover element 20. Anti-reflective film 24 allows for a greater amount of ambient light to be received through cover element 20 and strike holographic film element 18, thus providing a brighter holographic display on holographic tile 10. Anti-reflective film 24 can comprise, for example, a single layer coating (e.g., magnesium fluoride) or a silica-based multi-layer coating, although other anti-reflective films/coatings are also envisioned.

For securing holographic film element 18 to each of the tile substrate 16 and cover element 20, an adhesive or resin is included in holographic tile 10. A first resin layer 26 is deposited between tile substrate 16 and a back surface 28 of holographic film element 18. A second resin layer 30 is deposited between the front surface 22 of holographic film element 18 and cover element 20. In one embodiment, first and second resin layers 26, 30 are composed of polyvinyl butyral (PVB), which provides optimal binding and optical clarity properties (i.e., a transparent resin). It is also envisioned, however, that other resins or adhesives could also be used the exhibit desirable adhesion, optical clarity, toughness, and flexibility properties. Additionally, while both the first and second resin layers 26, 30 are described above as being comprised of PVB, it is further envisioned that second resin layer 30 be comprised of a non-transparent resin or adhesive. That is, as it is not necessary for any ambient light to pass through second resin layer 30, it is recognized that second resin layer 30 could be comprised of either a transparent or non-transparent resin.

In constructing holographic tile 10, the cover element 20 is cast in a mold to a desired thickness and shaped typically with a flat planar surface on each side and beveled or curved edges on one side. Second resin layer 30 is applied and coated over a back side 31 of cover element 20. The front surface 22 of holographic film element 18 is then pressed firmly against the second resin layer 30 with a roller or other similar mechanism so that bubbles are removed that would otherwise impede the visual appearance of the holographic element 18. First resin layer 26 is then applied to a front surface 33 of tile substrate 16, and the tile substrate 16 is pressed against back surface 28 of holographic film element 18. Once the resins 26, 30 have hardened, the holographic tile 10 can be affixed to a wall surface or bathroom shower vertical surface through conventional adhesives.

When first and second resin layers 26, 30 are comprised of polyvinyl butyral, heat and pressure is applied to holographic tile 10 at regulated speeds to ensure a bond between tile substrate 16, holographic film element 18, and cover element 20. In one embodiment, holographic tile 10 is loaded into an autoclave, which employs high pressure and heat to ensure a stronger bond between each of the tile substrate 16, holographic film element 18, and glass cover element 20, and the PVB resin layers 26, 30. The stronger, tighter bonds created by such a process helps to protect holographic film element 18 from the humidity and moisture typically found in a bathroom environment.

Referring now to FIG. 3, in another embodiment of the invention, a holographic tile 32 is further protected from humid environmental conditions by sealing a perimeter of the tile. That is, a cover element 34 is formed so as to protrude down from a front edge 36 of holographic tile 32. Cover element 34 extends downward past a holographic film element 38 included in holographic tile 32 and comes in contact with a tile substrate 40 that forms a back edge of holographic tile 32. To seal holographic film element 38 from the ambient environment, cover element 34 can be bonded to tile substrate 40 during an annealing process of the cover element. (i.e., edge slumping). The bonded perimeter formed by the joining of cover element 34 and tile substrate 40 thus provides a moisture resistant barrier that protects holographic film element 38.

It is recognized that the holographic film element included in holographic tile 10, 32 can include any of a variety of patterns holographic patterns thereon. An example of such a pattern formed on holographic film element 42 is shown in FIG. 4. In one embodiment, the pattern 44 is formed on holographic film element 42 by way of an embossing process. The embossed pattern 44 allows for holographic film element 42 to selectively diffract light of two or more wavelengths to produce a holographic image. It is also envisioned, however, that other processes can also be used to form a holographic pattern, such as by depositing a hologram sensitive material sensitive to green and red light in a patterned manner on a PET substrate of holographic film element 42. Such a patterned deposition also allows for the selective diffraction of light of two or more wavelengths to produce a holographic image.

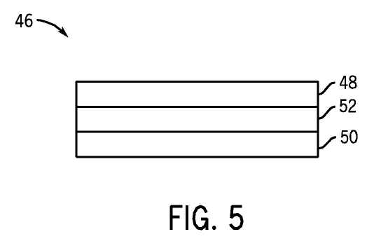

While the holographic tile 10, 32 in FIGS. 2 and 3 is shown as including a single holographic film element 18, 38, it is envisioned that the holographic film can be comprised of multiple layers that are adhered together. Referring to FIG. 5, a holographic film element 46 is shown having a first holographic layer 48 and a second holographic layer 50, which as set forth above, can each be comprised of a metalized PET film. The first and second holographic layers 48, 50 are adhered together via a transparent resin layer 52, such as polyvinyl butyral (PVB), to provide optimal binding and optical clarity properties. While being shown as including only first and second holographic layers 48, 50, it is also envisioned that holographic film element 46 could be comprised of additional holographic layers (e.g., 3 or 4 layers), with a layer of transparent resin included in between each of those layers. The plurality of holographic layers included in holographic film element 46, along with any embossed/etched pattern (see FIG. 4) formed thereon, achieves the visual effect of depth in a resulting holographic image. That is, the multiple holographic layers create a three-dimensional (3D) image visual effect that can further enhance the decorative qualities of the holographic tile. The multi-layer holographic film element 46 can be incorporated into either of the holographic tiles 10, 32 shown in FIGS. 2 and 3, to provide a further visually distinct holographic tile.

Therefore, according to one embodiment of the present invention, a decorative tile element includes a tile substrate, a first resin layer affixed to the tile substrate, and a holographic film element attached to the first resin layer and configured to receive ambient light and diffract the ambient light. A second resin layer is affixed to the holographic film element and a cover element is attached to the second resin layer and configured to allow the passage of the ambient light therethrough.

According to another embodiment of the present invention, a holographic tile for use as a decorative element includes a metalized polyethylene terephthalate (PET) film having a front side and a back side. The front side of the PET film is configured to diffract light received thereby to produce a holographic image. The holographic tile also includes a resin applied to each of the front and back sides of the metalized PET film, a transparent surface element bonded to the resin and adjacent to the front side of the metalized PET film, and a substrate bonded to the resin and adjacent to the back side of the metalized PET film.

According to yet another embodiment of the present invention, a method of constructing a decorative tile includes the steps of affixing a back surface of a holographic film element to a tile substrate and applying a transparent resin to a front surface of the holographic film element, the front surface of the holographic film element configured to receive and diffract ambient light. The method also includes the step of securing a cover element to the transparent resin applied to the front surface of the holographic film element, wherein the cover element is configured to allow the passage of the ambient light therethrough.

The present invention has been described in terms of the preferred embodiment, and it is recognized that equivalents, alternatives, and modifications, aside from those expressly stated, are possible and within the scope of the appending claims.

What is claimed is:

1. A decorative tile element comprising:
a tile substrate;
a first resin layer affixed to the tile substrate;
a holographic film element attached to the first resin layer and configured to receive ambient light and diffract the ambient light;
a second resin layer affixed to the holographic film element; and
a cover element attached to the second resin layer and configured to allow the passage of the ambient light therethrough.

2. The decorative tile element of claim 1 wherein the decorative tile element is configured as one of a shower tile, a floor tile, a wall tile, and a backsplash tile.

3. The decorative tile element of claim 1 wherein the holographic film comprises a metalized polyethylene terephthalate (PET) film.

4. The decorative tile element of claim 1 wherein the holographic film element comprises a front surface having an embossed decorative pattern thereon.

5. The decorative tile element of claim 1 wherein the holographic film element comprises a plurality of holographic layers.

6. The decorative tile element of claim 5 further comprising a transparent resin layer positioned between each of the plurality of holographic layers.

7. The decorative tile element of claim 1 wherein the first and second resin layers comprise polyvinyl butyral.

8. The decorative tile element of claim 1 wherein the tile substrate is bonded to the cover element such that the holographic film element is sealed from water vapor and humidity.

9. The decorative tile element of claim 1 wherein the cover element comprises a glass cover.

10. The decorative tile element of claim 1 further comprising an anti-reflective film applied to the cover element.

11. A holographic tile for use as a decorative element comprising:
a metalized polyethylene terephthalate (PET) film having a front side and a back side, the front side configured to diffract light received thereby to produce a holographic image;
a resin applied to each of the front and back sides of the metalized PET film;
a transparent surface element bonded to the resin and adjacent to the front side of the metalized PET film; and
a substrate bonded to the resin and adjacent to the back side of the metalized PET film.

12. The holographic tile of claim 11 wherein the resin comprises a transparent resin.

13. The holographic tile of claim 11 wherein the transparent resin comprises polyvinyl butyral.

14. The holographic tile of claim 10 configured as one of a shower tile, a floor tile, a wall tile, and a backsplash tile.

15. A method of constructing a decorative tile comprising the steps of:
affixing a back surface of a holographic film element to a tile substrate;
applying a transparent resin to a front surface of the holographic film element, the front surface of the holographic film element configured to receive and diffract ambient light;
securing a cover element to the transparent resin applied to the front surface of the holographic film element, wherein the cover element is configured to allow the passage of the ambient light therethrough.

16. The method of claim 15 wherein the step of affixing comprises applying the transparent resin to the back surface of the holographic film element.

17. The method of claim 16 wherein applying the transparent resin to the front and back surfaces of the holographic film element comprises applying polyvinyl butyral to the front and back surfaces of the holographic film element.

18. The method of claim 17 further comprising applying heat and pressure to the polyvinyl butyral to cure the transparent resin.

19. The method of claim 15 further comprising fashioning the decorative tile into one of a shower tile, a floor tile, a wall tile, and a backsplash tile.

20. The method of claim 15 wherein the holographic film element comprises a metalized polyethylene terephthalate (PET) film.
